(19) United States
(12) Patent Application Publication
(10) Pub. No.: US 2015/0208165 A1
(43) Pub. Date: Jul. 23, 2015

(54) Microphone Apparatus and Method To Provide Extremely High Acoustic Overload Points

(71) Applicant: Knowles Electronics, LLC, Itasca, IL (US)

(72) Inventors: Martin Volk, Willowbrook, IL (US); Robert A. Popper, Lemont, IL (US); Sarmad Qutub, Des Plaines, IL (US)

(21) Appl. No.: 14/600,475

(22) Filed: Jan. 20, 2015

Related U.S. Application Data
(60) Provisional application No. 61/929,693, filed on Jan. 21, 2014.

(51) Int. Cl. H04R 3/00

(52) U.S. Cl. CPC H04R 3/00; H04R 2430/00; H04R 2201/003

(57) ABSTRACT

An acoustic apparatus includes a first acoustic sensor that has a first sensitivity and a first output signal; a second acoustic sensor that has a sensitivity, the second sensitivity is less than the first sensitivity, and the second acoustic sensor has a second output signal; and a blending module that is coupled to the first acoustic sensor and the second acoustic sensor. The blending module is configured to selectively blend the first output signal and the second output signal to create a blended output signal.

### CROSS REFERENCE TO RELATED APPLICATION

This application which claims the benefit of U.S. Provisional Application No. 61/929,693 entitled “Microphone Apparatus and Method to Provide Extremely High Acoustic Overload Points” filed Jan. 21, 2014, the contents of which are incorporated herein by reference in its entirety.

### TECHNICAL FIELD

This application relates to microphone systems and, more specifically, to the operation of these devices and systems.

### BACKGROUND OF THE INVENTION

Various types of acoustic devices have been used over the years. One example of an acoustic device is a microphone. Generally speaking, a microphone converts sound pressure into an electrical signal.

Microphones sometimes include multiple components that include micro-electro-mechanical systems (MEMS) and integrated circuits (e.g., application specific integrated circuits (ASICs)). A MEMS die typical has disposed on it a diaphragm and a back plate. Changes in sound pressure move the back plate which changes the capacitance involving the back plate thereby creating an electrical signal. The MEMS dies are typically disposed on a base or substrate along with the ASIC and then both are enclosed by a lid or cover. Another type of microphone is a condenser microphone. The operation of condenser microphones is also well known to those skilled in the art.

The Acoustic Overload Point (AOP) describes the input sound pressure level into a microphone that causes unacceptable distortion on its output (typically 10%), and this parameter is often expressed in units of dBSPL. Wind and loud noises force microphones to exceed their AOP. Exceeding the AOP causes, clipping of the output signals. Input sound pressure levels beyond the AOP of the microphone typically make voice signals unintelligible and foils other signal processing that is intended to reduce noise.

Some previous microphone systems have used dual microphones (one normal AOP and one high AOP) that are each operated separately under different conditions. Operation of these microphones is controlled by switching between these devices. Unfortunately, the action of switching introduces unwanted artifacts and noise into the output signals of these devices and this has limited their performance. This has resulted in some user dissatisfaction with the above-mentioned microphone systems.

### BRIEF DESCRIPTION OF THE DRAWINGS

For a more complete understanding of the disclosure, reference should be made to the following detailed description and accompanying drawings wherein:

FIG. 1 comprises a block diagram of a microphone control system according to various embodiments of the present invention;

FIG. 2 comprises a table illustrating the operation of the RMS to DC converter system of FIG. 1 according to various embodiments of the present invention;

FIG. 3 comprises a graph of the operation of the system of FIG. 1 including the fader circuit according to various embodiments of the present invention;

FIG. 4 comprises a graphs of various waveforms produced by the system of FIG. 1 according to various embodiments of the present invention.

FIG. 5 comprises a block diagram of a microphone that provides a blended analog output according to various embodiments of the present invention;

FIG. 6 comprises a block diagram of a microphone that provides a blended digital output according to various embodiments of the present invention;

FIG. 7 comprises a block diagram of a microphone that provides a blended digital output according to various embodiments of the present invention;

FIG. 8 comprises a block diagram of a microphone that provides a blended digital output according to various embodiments of the present invention;

FIG. 9 comprises a block diagram of a blend circuit approaches according to various embodiments of the present invention;

FIG. 10 comprises a graph showing some advantages of the present approaches according to various embodiments of the present invention;

FIG. 11 comprises a block diagram of a speaker that can be utilized as a microphone according to various embodiments of the present invention;

FIG. 12 comprises a block diagram of a system that uses a speaker that is utilized as a microphone according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Approaches are provided that allow for the control of Acoustic Overload Point (AOP) of microphones and systems that utilize these devices. More specifically and in one aspect, a first signal from a standard AOP microphone (provided for good sensitivity and signal-to-noise ratio (SNR)) is blended or mixed with a second signal from a high AOP device (e.g., a miniature speaker) when the input sound pressure level to the first device exceeds its AOP. The selective blending of the signals from the two devices mitigates or eliminates the problems associated with switching such as the introduction of unwanted artifacts into the output signal.

In other aspects, the mixing reduces the amplitude of unwanted signals (e.g., noise or distortions) from the first microphone while increasing the amplitude of the good (undistorted) signal from the second microphone or speaker keeping the blended output level constant. Blending control is also integrated into the device providing the user with a single chip solution for an ultra-high AOP microphone using standard components. In other words, instead of having to dispose the various components of the system in multiple locations, these components can be disposed on a single chip. In some other aspects and as mentioned, the approaches described herein utilize a standard miniature speaker for the high AOP device. Other examples are possible.

It will be appreciated that the microphones and speakers used herein can have any desired configuration or construction. For example, the microphones may be MEMS microphones, condenser, or piezoelectric microphones. Other examples of microphones and speakers are possible.

In some aspects, the present approaches provide for a blending of signals representing incoming sensed sound pressures, where the signals are received from two or more transducers. Based upon the sound pressure level of the incoming signals, a first signal from a nominal sensitivity MEMS device is blended with a second signal associated with a lower sensitivity MEMS device. Several approaches (e.g., weighting the signals by multiply each signal with complementary coefficients based upon the signal level of one of the transducers) could be utilized to achieve the blending. As the sound pressure level increases and in another aspect, the blend uses more of the signal received from the low sensitivity MEMS device than the signal received from the nominal (or higher) sensitivity MEMS device. In some examples, there are both digital and analog outputs provided for the resultant combined signal. In another aspect, the particular blend that is used is based upon the output of the nominal MEMS device. These approaches also provide for a high acoustic overload point (AOP). By “high” AOP, it is meant that the AOP is higher and improved relative to nominal values of conventional MEMS microphones.

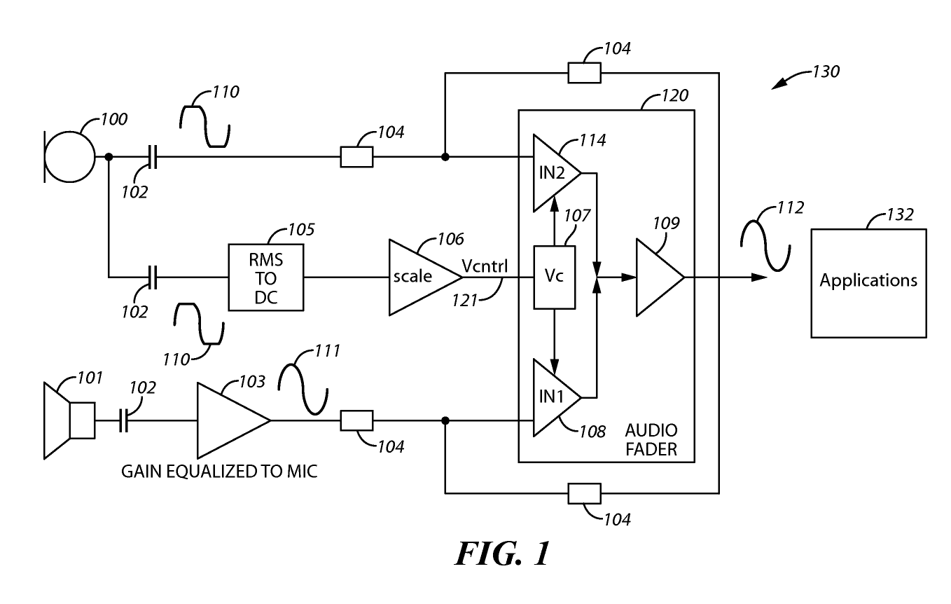

Referring now to FIG. 1, one example of a system or apparatus 130 for microphone signal blending and control is described. As will be disclosed and described below, this system 130 provides blending and control functions using a standard analog microphone and a standard speaker as the high AOP device. It will be appreciated that the speaker is operated “in reverse” as a microphone in this instance so as to provide a device with an extremely high AOP. As shown in FIG. 1, the gain at the output of the blending circuit (the output of the device 109) remains constant as the sum of the gains (AVIN1+AVIN2) of individual amplifiers (amplifiers 108 and 114) equals 1 no matter what the input level of the microphone.

As shown, the system 130 includes a standard Acoustic Overload Point (AOP) and nominal sensitivity microphone 100 (e.g., having an AOP of approximately 122 dB SPL), a miniature speaker 101 (in this example, used as a low sensitivity, high AOP device and having an AOP of approximately 160+dBSPL and operated as a microphone not as a speaker), direct current (DC) blocking capacitors 102 (used to remove DC bias from AC Signal), a speaker signal amplifier 103 (that boosts the level of the speaker output so it is the same as the microphone's for the same input sound level), feedback resistors 104 (used to set the maximum gain of each of a first variable gain amplifiers (VGA) 108 and a second VGA 114), a RMS to DC convertor 105 (that converts the AC signal to a DC level that is proportional to the AC RMS level), and a scaling circuit 106 (that amplifies the DC level so that when the output of the microphone approaches its AOP, an audio fader circuit 120 will fade out the microphone signal and use only the undistorted speaker signal).

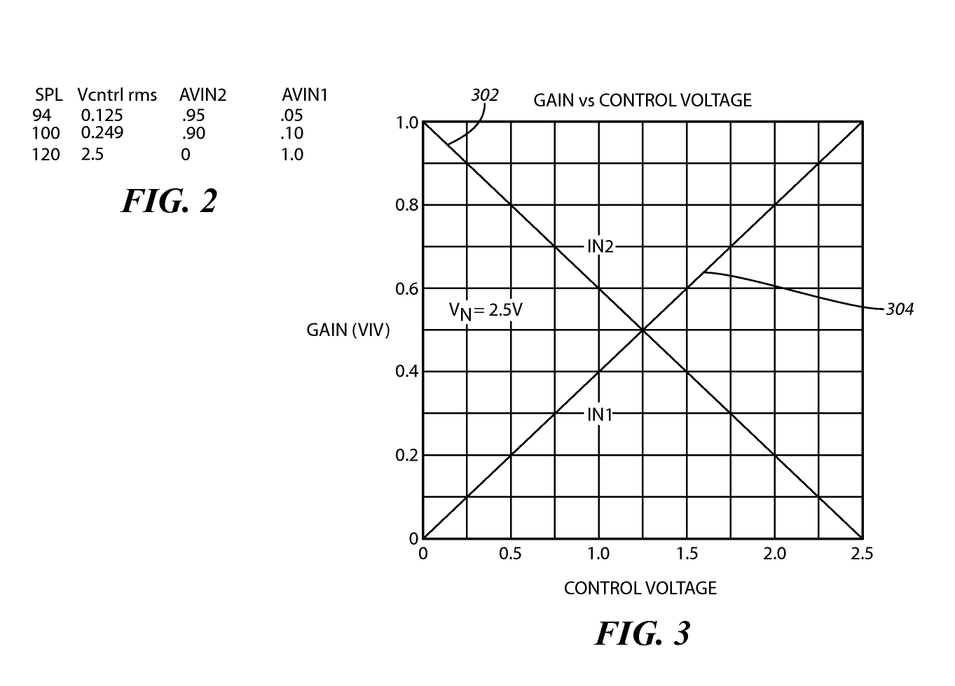

It will be appreciated that the RMS to DC converter 105 may implement the table shown in FIG. 2. Generally speaking, the RMS to DC converter 105 receives a wave form (e.g., a waveform 110) from the microphone 100 and converts the root mean squared (RMS) value of this AC waveform into a DC voltage. And, as the waveform input into the RMS to DC converter 105 changes, the output DC voltage changes. As the DC voltage changes, the gains of the first VGA 108 and second VGA 114 change. The changing gains affect the percentages of the signal components of the blended output signal (output of device 109) that originates from the microphone 100 and the speaker 101. For example, when the DC voltage is low, approximately 95% of the blended signal originates from the microphone 100 and approximately 5% originates from the speaker 101 depending on and proportional to the output of the microphone 100. When the DC voltage is high, approximately 0% of the blended signal originates from the microphone 100 and approximately 100% originates from the speaker 101 depending on and proportional to the output of the microphone 100. It will be appreciated that these values are examples only and that other examples are possible.

The audio fader circuit 120 includes the first VGA 108, the second VGA 114, a control voltage conditioner 107 (that supplies the correct gain control signal to the VGA 108 and VGA 114 so one amplifier's gain is increasing as the other amp gain is decreasing). The output of the control voltage conditioner can be either a voltage or current depending on the IC topology. Each of the first VGA 108 and the second VGA 114 amplifies its input according to the gain control signal and feedback resistors. The gain of the first VGA 108 is AVIN1 and the gain of the second VGA 114 is AVIN2. The first VGA 108 and the second VGA 114 can be or can utilize voltage or current feedback depending on IC topology (i.e., the topology of the integrated circuit on which these devices are residing).

The fader circuit 120 may also include a summing amplifier 109 that sums the outputs of the VGA 108 and 114 into a single output. The amplifier 109 may sum voltages or currents depending on the IC topology.

In one example of the operation of the system of FIG. 1, the microphone 100 and speaker 101. Waveform 110 is a diagram of a distorted signal produced by the microphone 100 when its input AOP level is exceeded. Waveform 111 is a diagram of the signal the speaker 101 produces under the same conditions that cause the signal of the microphone 100 to distort.

Waveform 112 is a diagram of the blended output signal when the input sound pressure level to the microphone 100 and the speaker 101 is high enough to cause distortion on the microphone output.

The output of the system 130 drives applications 132. The applications 132 may include cellular phone applications, video camera applications, voice recorder applications, microphone arrays, security and surveillance systems, notebook personal computers (PCs), laptop PCs, and wired or wireless headset applications to mention a few examples. Other examples are possible. The applications 132 may be electronic components, software components, or combinations of hardware and software applications.

Referring now to FIG. 2, one example of a table of values that describe the operation of the RMS to DC converter 105 is described. The table shows a desired signal pressure level, the value of Vcntrl 121 in FIG. 1, and the gains of the first amplifier 108 and the second amplifier 108. The gains of VGAs 108 and 114 control the amount of the mixed signal originating from the microphone 100 and the speaker 101. Generally speaking, as the amount of distortion increases in the microphone signal, more signal is used from the speaker. At low RMS levels, no distortion is likely to be present so only a small amount of the mixed signal will be from the speaker. In one aspect, in these low ranges a small signal is always used from the speaker 101.

The changing gains are shown in this table and these changing gains affect the percentage of the blended output signal (output of device 109) that originates from the microphone 100 and the speaker 101. For example, when the DC voltage is low at 0.125 V(rms), approximately 95% of the blended signal originates from the microphone 100 and approximately 5% originates from the speaker 101. When the DC voltage is high 2.5 V (rms), approximately 0% of the blended signal originates from the microphone 100 and approximately 100% originates from the speaker 101. It will be appreciated that these values are examples only and that other examples are possible.

Referring now to FIG. 3, a graph showing the normalized gain versus the control voltage into the fader 120 is described. This graph describes operation of the fader circuit 120. The x-axis shows Vcntrl signal 121 (output of scale circuit 106). The y-axis shows an amplifier gain. A first curve 302 shows the gain of the second amplifier 114 and shows as the voltage increases, the gain decreases. A second curve 304 shows the gain of the first amplifier 108 and as the voltage of the microphone increases this gain increases. This allows more of the sound of the speaker 101 sound to be let through.

The changing gains of the VGAs 108 and 114 affect the percentage of the blended output signal (output of device 109) that originates from the microphone 100 and the speaker 101. For example, when the DC voltage is low (the first microphone is operating below its AOP operating point), the gain of the second VGA 114 is high, the gain of the first VGA 108 is low, and approximately 95% of the blended signal originates from the microphone 100 and approximately 5% originates from the speaker 101. When the DC voltage is high (the microphone is operating beyond its AOP point), the gain of the second VGA 114 is low, the gain of the first VGA 108 is high, and approximately 0% of the blended signal originates from the microphone 100 and approximately 100% originates from the speaker 101. It will be appreciated that these values are examples only and that other examples are possible.

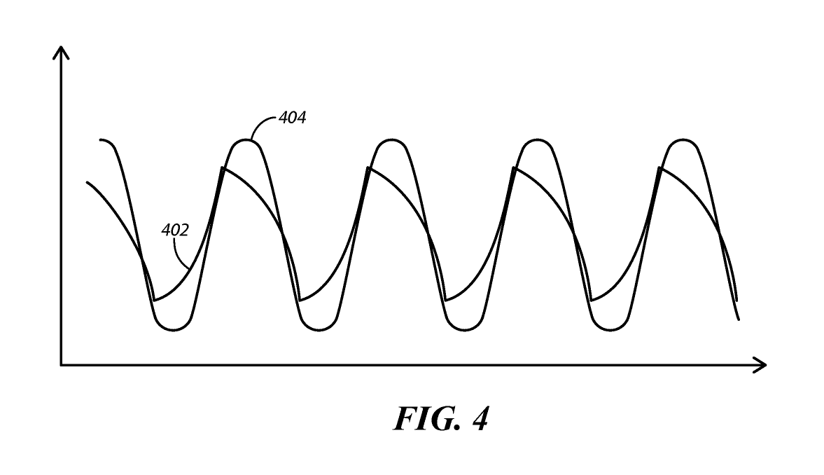

Referring now to FIG. 4, a graph of the circuit response showing the clipped microphone input 402 (when the AOP level of this microphone is exceeded) and the blended circuit output 404, which is derived from the signal produced by the speaker. It can be seen that the output 404 of the blended circuit is not distorted. Since the microphone output is distorted due to its AOP being exceed, the speaker output signal is used as a relatively high portion of the blended output.

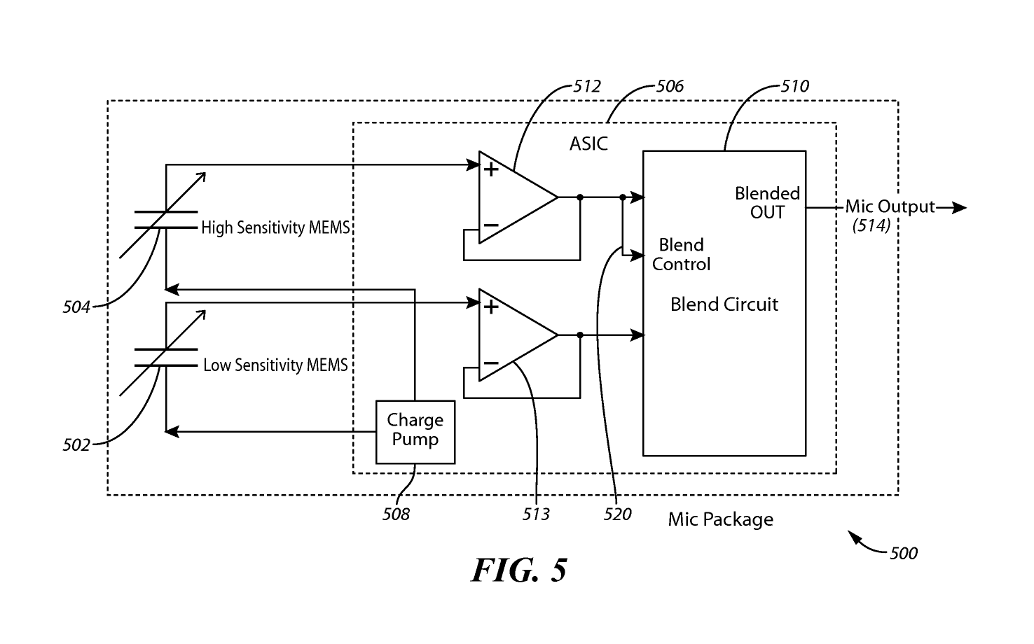

Referring now to FIG. 5, one example of a microphone 500 is described. The microphone 500 includes a low sensitivity microelectromechanical system (MEMS) device 502, a high (or nominal) sensitivity MEMS device 504, an application specific integrated circuit (ASIC) 506, and amplifiers 512 and 513. Disposed on the ASIC 506 is a charge pump 508 (that is coupled to the MEMS devices 502 and 504), and a blend circuit 510. The amplifiers 512 and 513 provide an amplified analog input to the blend circuit 510. An adjustable DC level 520 is taken from the output of the amplifier 512 and used to control the blend level of the blend circuit 510. In other aspects, the adjustable DC level 520 may be provided by a feedback from the microphone's output that converts the V_{RMS} signal into a DC level. It will be appreciated that other transducers (e.g., piezoelectric devices) can be used in place of the MEMS devices described herein.

As used herein, “sensitivity” refers to the output of the microphone when a 1 kHz sine wave signal is generated at 1 Pascal. This is one example of an industry standard, though other definitions may apply. Mainly, the examples described in this patent are in regards to two transducers with different sensitivities and, potentially, different characteristics.

As used herein a “nominal” or “high” sensitivity refers to a transducer that is more sensitive and better tuned to detect low level acoustic signals while “low” sensitivity refers to a transducer that is less sensitive at detecting low level acoustic signals and requires louder or larger acoustic signals to be generated for detection. The MEMS devices 502 and 504 include a diaphragm and a back plate. Movement of the diaphragm by sound energy creates an electrical signal representative of the received sound energy. One of the MEMS devices is configured to provide nominal sensitivity while the other is configured to provide for a lower sensitivity.

The blend circuit 510 blends the signals received from the MEMS device 502 and MEMS device 504 and this blending is controlled by a control signal such as an adjustable DC level 520 for example. Other examples of control signals are possible. In one example, the particular blend that is used (and indicated by DC level 520) is based upon the output of the nominal MEMS device 504. Regarding how the signals are blended, the approach of FIG. 5 effectively multiplies each signal by a coefficient dependent on the output of the nominal or lower MEMS device 504. This coefficient defines the percentage of each of the two signals (nominal MEMS signal and low sensitivity MEMS signals) that are present in the final output. After each of the signals are multiplied by the coefficient, the two multiplied signals are added together (either literally or effectively) to form the final blended signal at the output of the blend circuit 510.

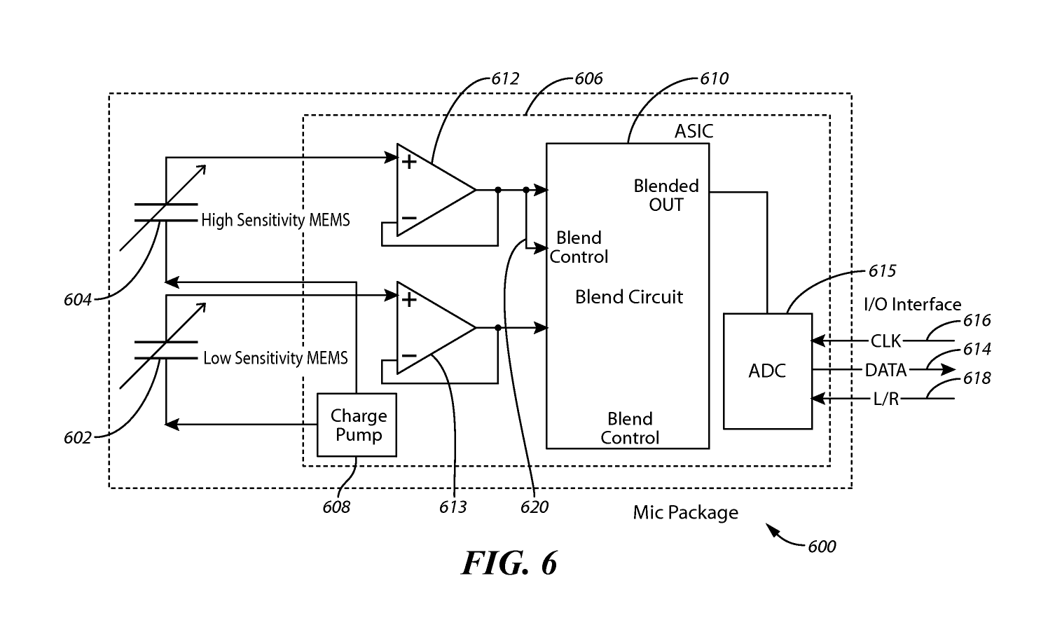

Referring now to FIG. 6, another example of a microphone 600 is described. The microphone 600 includes a low sensitivity microelectromechanical system (MEMS) device 602, a high (or nominal) sensitivity MEMS device 604, an application specific integrated circuit (ASIC) 606, and amplifiers 612 and 613. Disposed on the ASIC 606 is a charge pump 608 (that is coupled to the MEMS devices 602 and 604), and a blend circuit 610. The amplifiers 612 and 613 provides an amplified analog input to the blend circuit 610. An adjustable DC level 620 is taken from the output of the amplifier 612 and used to control the blend level of the blend circuit 610. In other aspects, the adjustable DC level 620 may be provided by a feedback from the microphone's output that converts the V_{RMS} signal into a DC level. It will be appreciated that other transducers (e.g., piezoelectric devices) can be used in place of the MEMS devices described herein.

Also disposed on the ASIC 606 is an analog-to-digital converter (e.g., a sigma delta modulator) 615. The analog-to-digital converter 615 converts the analog signal received from the blend circuit 610 and converts this into a digital signal 614. The analog-to-digital converter 615 receives a clock signal 616 and a line select signal 618 to define whether data will be on the left or right clock edge from an external source such as a digital signal processor or a codec. The adjustable DC level 620 is used to control the blend level of the blend circuit 610. It will be appreciated that other transducers (e.g., piezoelectric devices) can be used in place of the MEMS devices described herein.

The blend circuit 610 blends the signals received from the MEMS device 602 and MEMS device 604 together and this blending is controlled by a control signal such as an adjustable DC level 620. In one example, the particular blend that is used (and indicated by the DC level 620) is based upon the output of the nominal or lower MEMS device 604. Other example are possible. Regarding how the signals are blended, the approach of FIG. 6 effectively multiplies each signal by a coefficient dependent on the output of the nominal MEMS device 604. This coefficient defines the percentage of each of the two signals (nominal MEMS signal and low sensitivity MEMS signal) that are present in the final output. After each of the signals are multiplied by the coefficient, the two multiplied signals are added together (either literally or effectively) to form the final blended signal at the output of the blend circuit 610.

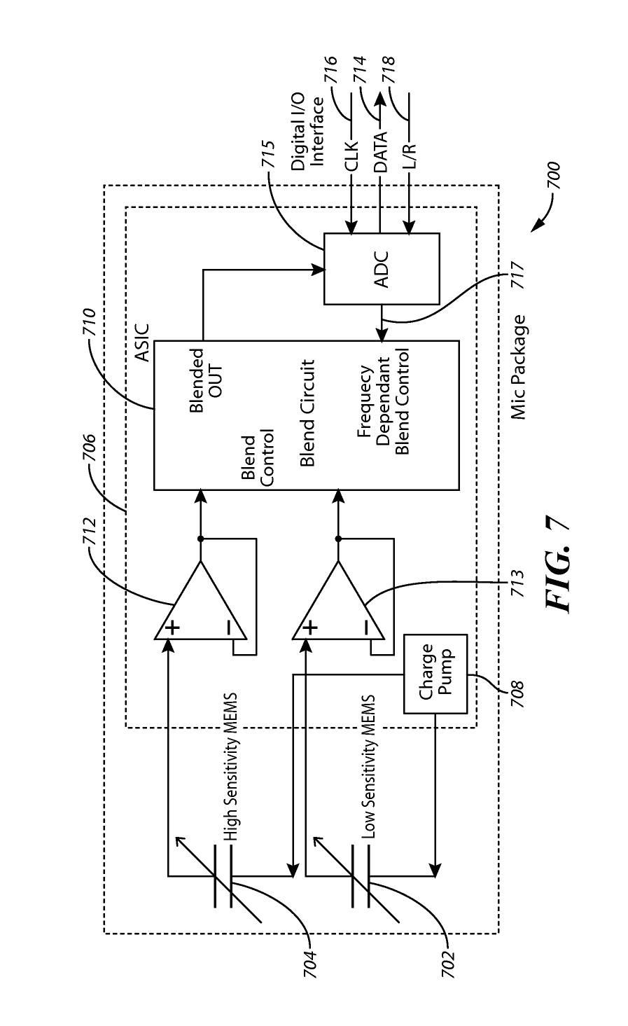

Referring now to FIG. 7, another example of a microphone 700 is described. The microphone 700 includes a low sensitivity microelectromechanical system (MEMS) device 702, a high (or nominal) sensitivity MEMS device 704, an application specific integrated circuit (ASIC) 706, and amplifiers 712 and 713. Disposed on the ASIC 706 is a charge pump 708 (that is coupled to the MEMS devices 702 and 704), and a blend circuit 710. The amplifiers 712 and 713 provides an amplified analog input to the blend circuit 710. Also disposed on the ASIC 706 is an analog-to-digital converter (e.g., a sigma delta modulator) 715. The analog-to-digital converter 715 converts the analog signal received from the amplifier 712 and converts this into a digital signal 714. The analog-to-digital converter 715 receives a clock signal 716 and a line rate signal 718 from an external source such as a digital signal processor or a codec. The analog-to-digital converter 715 sends a signal 717 to the blend circuit 710 to control the blend rate. This signal may be generated by an internal oscillator inside of the microphone. It will be appreciated that other transducers (e.g., piezoelectric devices) can be used in place of the MEMS devices described herein.

The blend circuit 710 blends the signals received from the MEMS device 702 and MEMS device 704 together and this blending is controlled by control 717 from the analog-to-digital converter 715 that is defined by the clock signal 716. One reason to use signal 717 to control the blend is to define multiple modes of operation with different AOP thresholds. The multiple modes may yield differences in other acoustic and electrical parameters such as sensitivity or power consumption. In one example, the particular blend that is used is based upon the output of the nominal MEMS device 704. Regarding how the signals are blended, the approach of FIG. 7 effectively multiplies each signal by a coefficient dependent on the control signal 717 that is at least partially defined or controlled by the clock signal 716. This coefficient defines the percentage of each of the two signals (nominal MEMS signal and low sensitivity MEMS signal) that are present in the final output. After each of the signals are multiplied by the coefficient, the two multiplied signals are added together (either literally or effectively) to form the final blended signal. The interface shown is for a standard PDM interface, but other standard digital interfaces that use a clock signal are possible.

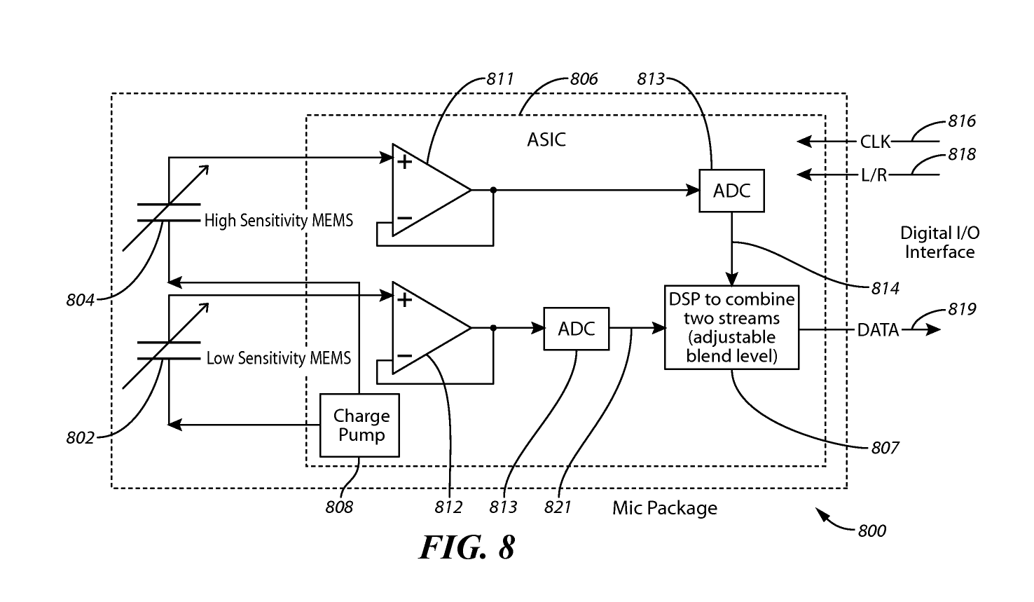

Referring now to FIG. 8, another example of a microphone 800 is described. The microphone 800 includes a low sensitivity microelectromechanical system (MEMS) device 802, a high (or nominal) sensitivity MEMS device 804, and an application specific integrated circuit (ASIC) 806. Disposed on the ASIC 806 is a charge pump 808 (that is coupled to the MEMS devices 802 and 804), a first amplifier 811, a second amplifier 812, a first analog-to-digital converter (e.g., a sigma delta modulator) 813, a second analog-to-digital converter (e.g., a sigma delta modulator 815), and a digital signal processor 807. The analog-to-digital converters 813 and 815 convert analog signals received from the amplifiers 811 and 812 into digital signals 814 and 821. The analog-to-digital converters 813 and 815 can be any digitizer that converts analog signals into digital signals such as PDM, PCM, PWM, or other. The analog-to-digital converter 813 receives a clock signal 816 and a line rate signal 818 from an external source such as a codec. The DSP 807 combines two input streams received via digital signal 814 into a blended signal 819. It will be appreciated that other transducers (e.g., piezoelectric devices and speakers) can be used in place of the MEMS devices described herein.

In this example, the DSP includes approaches (implemented in hardware and/or software) to blend the signals received from the MEMS device 802 and MEMS device 804 together. In one example, the particular blend that is used is based upon the output of the nominal MEMS device 804. Regarding how the signals are blended, the approach of FIG. 8 effectively multiplies each signal by adapting complementary coefficients dependent on the output of the nominal MEMS device 804 or the lower sensitivity MEMS device 802. This coefficient defines the percentage of each of the two signals (nominal MEMS signal and low sensitivity MEMS signal) that are present in the final output. After each of the signals are multiplied by the coefficient, the two multiplied signals are added together (either directly or indirectly) to form the final blended signal.

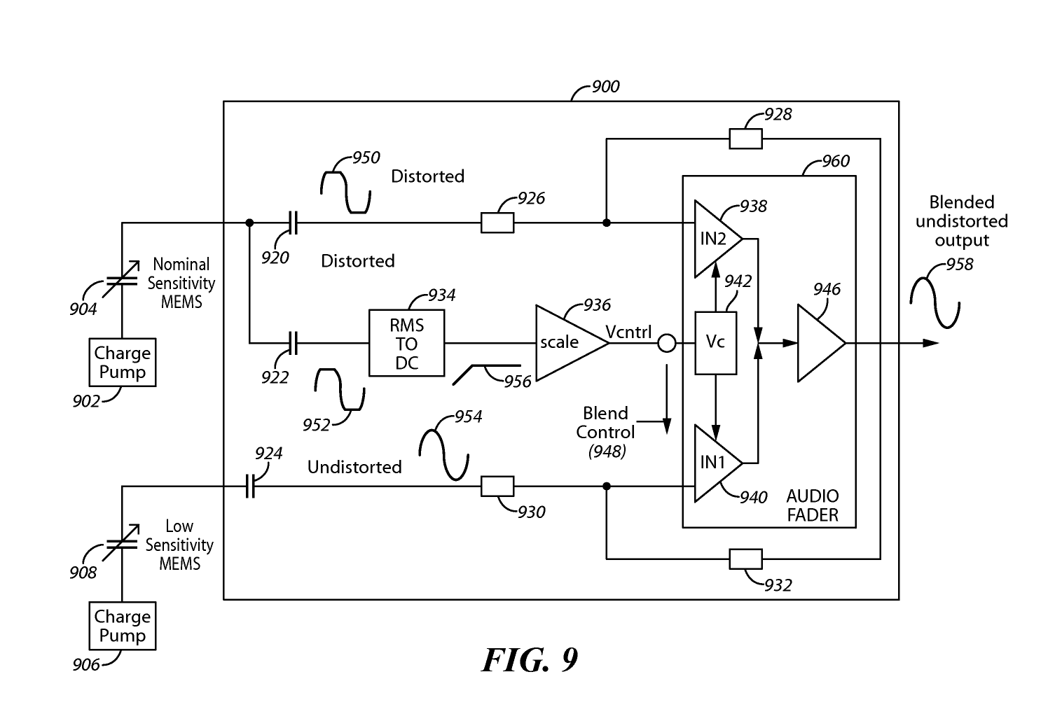

Referring now to FIG. 9, one example of a blend circuit 900 is described. The blend circuit 900 is coupled to a low sensitivity MEMS device 908 (that is charged by a charge pump 906) and a nominal sensitivity MEMS device 904 (that is charged by a charge pump 902). The blend circuit 900 includes a first capacitor 920, a second capacitor 922, a third capacitor 924, a first resistor 926, a second resistor 928, a third resistor 930, a fourth resistor 932, a RMS to DC module 934, a scale module 936, and an audio fader 960. The audio fader 960 includes a first amplifier 938, a second amplifier 940, a voltage control module 942, and a third amplifier 946. It will be appreciated that other transducers (e.g., piezoelectric devices) can be used in place of the MEMS devices described herein.

Signals are received from the nominal sensitivity MEMS device 904 and the low sensitivity MEMS device 908. In this example, the signals received from the nominal sensitivity MEMS device 902 are distorted while the signals received from the low sensitivity MEMS are undistorted at high sound pressure levels. The capacitors 920 and 922 receive distorted signals 950 and 952, respectively, and these capacitors remove the DC component of the signal and pass only the AC component (in other words AC coupling). The signal 950 is sent via resistor 926 to amplifier 938. The signal 922 is sent to RMS to DC module 934, which converts the signal 952 into a DC signal 956. Scale module 936 is used to scale the signals to usable levels by the blending circuit that requires voltages to be in a certain range.

The undistorted signal 954 is received by amplifier 940. The capacitor 924 removes the DC component of the signal and passes the AC component and the resistor 930 and 932 control the gain of the amplifier 940.

The blend control signal 948 is used by the audio fader 960 to adjust the gain of amplifiers 938 and 940, effectively adjusting the contributions and percentage of each of the signals to the final output signal 958.

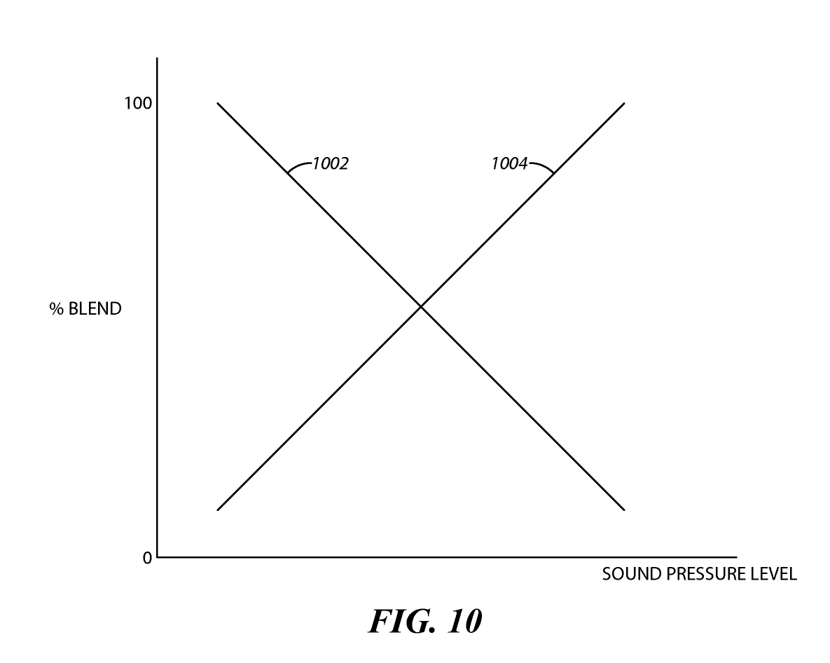

Referring now to FIG. 10, one example of a graph showing some of the advantages of the present approaches is described. The x-axis shows the sound pressure level (SPL) of incoming signals and the y-axis shows the percent blend. A first plot 1002 shows the percent blend of a nominal sensitivity transducer while a second plot 1004 shows the percent blend of a low sensitivity transducer. It can be seen that at low SPLs, the output of the nominal sensitivity transducer is used for a large part of the blend, while the output of the low sensitivity transducer is used for a low percent of the blend. As sound pressure levels increase, the composition of the blend changes such that a high SPLs, the output of the nominal sensitivity transducer is used for a low part of the blend, while the output of the low sensitivity transducer is used for a high percent of the blend.

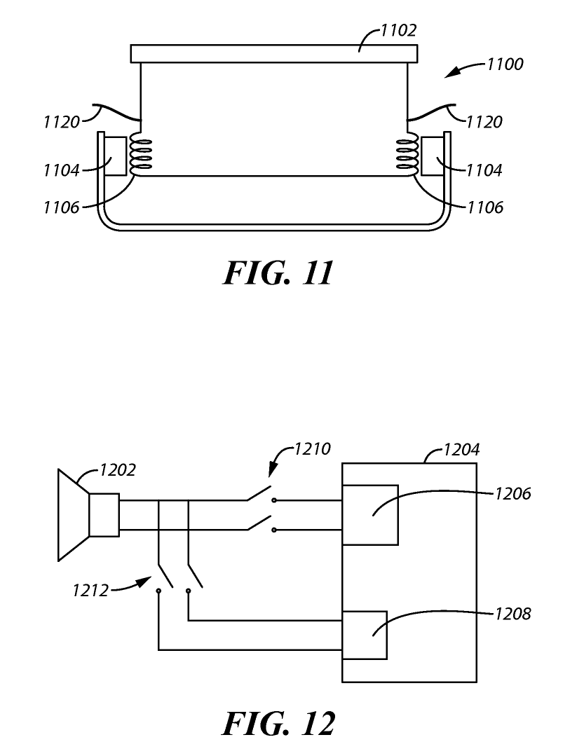

Referring now to FIG. 11, one example of a speaker that can be utilized as a microphone is described. The speaker 1100 of FIG. 11 is a dynamic speaker that in one mode of operation converts electrical energy (e.g., an electrical signal) into sound energy for presentation to a listener. However, the speaker 1100 can also be operated as a microphone so as to convert sound energy into an electrical signal. The speaker 1100 includes a diaphragm 1102, magnets 1104, and a coil 1106 all of which are disposed in an assembly or basket 1108. The coil 1106 is coupled to the diaphragm 1102. In a first mode of operation, the speaker 1100 is arranged to convert an electrical energy into sound energy. An electrical current is applied to the coil 1106. This application of an electrical current (via wires 1120) causes a magnetic field to be created. Excitation of the coil 1106 creates a magnetic field which, with the presence of the magnets 1104, causes the coil 1106 to move. The coil 1106 moves the diaphragm 1102 and coil 1102 in unison (mimicking the action of a moving piston), causing sound to be produced. Although the speaker 1100 is arranged to perform these operations (and is fully capable of performing these operations), the speaker may not be actually used to perform these operations. That is, an electrical current representing sound energy may never be applied to the coil.

In these regards, sound energy from an external source (e.g., a voice, music, to mention two examples), may be incident and applied to the diaphragm 1102 via wires 1120. This moves the diaphragm 1102 and this causes the coil 1106 to move. A magnetic field is created with the magnets 1104. As the magnetic field changes with the moving coil 1102, a current is created in the coil 1106 (representative of the incident sound energy) that is transmitted away from the speaker (via wires connected to the coil 1106) to be processed by another electronic device. In this way, a speaker that is arranged to convert electrical current into sound energy is used to perform the opposite function—converting sound energy into electrical current that is transmitted to another device.

Referring now to FIG. 12, one example of a system that uses a speaker as a microphone and as a speaker is described. A speaker 1202 is coupled to an integrated chip 1204 that includes an amplifier 1206 (e.g., a D class amplifier) and an Analog-to-Digital (A-to-D) converter 1208 (e.g., a sigma delta modulator). Although shown as being disposed on a single integrated chip 1204 (e.g., a codec), the amplifier 1206 and A-to-D converter 1208 may also be disposed on separate integrated chips. Switches 1210 (e.g., controlled by a controller) control whether the amplifier sends signals to the speaker 1202 (for the speaker 1202 to convert these signals into sound energy) and switches 1212 (e.g., controlled by a controller) control whether the speaker 1202 (acting as a microphone) send electrical current representing sound energy to the A-to-D converter 1208. In one aspect, the switches 1210 and 1212 can be either electrical or mechanical switches. The speaker 1202 in one aspect may be configured as described with respect to FIG. 11.

It will be appreciated that the speaker that is utilized as a microphone can be used in other systems. For example, the output of the speaker may be coupled to a microphone as well.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An acoustic apparatus, comprising:
a first acoustic sensor having a first sensitivity and having a first output signal;
a second acoustic sensor having a sensitivity, the second sensitivity being less than the first sensitivity, the second acoustic sensor having a second output signal;
a blending module coupled to the first acoustic sensor and the second acoustic sensor, the blending module configured to selectively blend the first output signal and the second output signal to create a blended output signal.

2. The acoustic apparatus of claim 1, wherein the blending module blends the first output signal and the second output signal based upon an input sound pressure to the first acoustic sensor.

3. The acoustic apparatus of claim 1, wherein the blending module blends the first output signal and the second output signal based upon an input sound pressure to the second acoustic sensor.

4. The acoustic apparatus of claim 1, wherein the second acoustic sensor is a speaker.

5. The acoustic apparatus of claim 1, wherein the first and second acoustic sensors comprises microelectromechanical system (MEM) transducers.

6. The acoustic apparatus of claim 1, wherein at least one of the sensors is a microelectromechanical system (MEM) transducer.

7. The acoustic apparatus of claim 1, where in at least one of the sensors is a piezoelectric transducer.

8. The acoustic apparatus of claim 1, wherein the blending module multiplies the first output signal and the second output signal by a coefficient based upon, at least in part, to the output of either of the two acoustic transducers.

9. The acoustic apparatus of claim 1, wherein the blended output signal is transmitted to an amplifier.

10. The acoustic apparatus of claim 1, wherein the blending module and amplifier are disposed on an application specific integrated circuit (ASIC).

11. The acoustic apparatus of claim 1, wherein the blended output signal is transmitted to a sigma delta modulator.

12. The acoustic apparatus of claim 1, wherein the blended output signal is transmitted to an analog to digital converter.

13. The acoustic apparatus of claim 1, wherein the blending module receives a frequency dependent control signal.

14. The acoustic apparatus of claim 1, wherein the blending module is disposed at a digital signal processing device (DSP) disposed outside of the microphone.

15. The acoustic apparatus of claim 1, wherein the blending module is disposed at a digital signal processing device (DSP) disposed inside of the microphone.

16. An acoustic speaker apparatus, comprising:
a flexible diaphragm;
at least one magnet;
a coil that is coupled to the diaphragm;
such that in a first mode of operation, applied current to the coil is effective to create a magnetic field, the magnetic field moving the coil, the moving coil causing a movement of the diaphragm to create sound energy;
such that in a second mode of operation, no external electrical current is applied to the coil, and sound energy is applied to the diaphragm to move the diaphragm, the moving diaphragm moving the coil, the moving coil creating a changing magnetic field, which creates an electrical current in the coil, which is transmitted to an external electronic device.

17. The apparatus of claim 16, wherein the coil is coupled to a codec.

18. The apparatus of claim 16, wherein the coil is coupled to an electronic network that includes at least one of a resistor, a capacitor, and an inductor.

19. The apparatus of claim 16, wherein the coil is coupled to an amplifier.

20. The apparatus of claim 17, wherein the codec includes an amplifier.

21. The apparatus of claim 17, wherein the codec includes an analog-to-digital converter.

22. The apparatus of claim 17, wherein the codec includes an amplifier and an analog-to-digital converter, and wherein the codec comprises a first integrated chip including the amplifier and a second integrated chip that includes the analog-to-digital converter.

23. The apparatus of claim 16, wherein the codec includes an amplifier, and an analog-to-digital converter and wherein the codec comprises a single integrated chip.

24. The apparatus of claim 16, wherein the coil is coupled to a microphone.

25. The apparatus of claim 16, where the speaker is configured, arranged, and to detect acoustic signals.

26. The apparatus of claim 16, where the speaker is configured to cause other integrated circuits disposed inside of an electronic device to change modes upon detection of an acoustic signal.
